(19) United States
(12) Patent Application Publication
(10) Pub. No.: US 2004/0216366 A1
(43) Pub. Date: Nov. 4, 2004

(54) Sticky ovitrap

(75) Inventors: Scott Alexander Ritchie, Queensland (AU); Sharron Anne Long, Queensland (AU)

Correspondence Address: NIXON & VANDERHYE, PC, 1100 N GLEBE ROAD, 8TH FLOOR, ARLINGTON, VA, 22201-4714, US

(73) Assignee: The State of Queensland through the Department of Health, Queensland (AU)

(21) Appl. No.: 10/661,866

(22) Filed: Sep. 15, 2003

(30) Foreign Application Priority Data
Apr. 11, 2003 (AU) 2003204705

(51) Int. Cl. A01M 1/14

(52) U.S. Cl. 43/114

(57) ABSTRACT

A sticky ovitrap comprises a container, the inside wall of the container being a dark colour, and a clear plastic strip member which contains a sticky clear adhesive, the strip member being attachable to the inside of the container. The sticky strip member catches insects and can be removed and placed on a light box to clearly identify the type of insect.

### FIELD OF THE INVENTION

This invention is directed to an ovitrap, and is particularly directed to an ovitrap having a particular type of insert to enable quick and efficient recognition of mosquitoes trapped in the ovitrap.

### BACKGROUND ART

An ovitrap is a small device placed at selected locations for detecting the presence of adult container-breeding mosquitoes. More specifically, the ovitrap is frequently used by mosquito control personnel to monitor container-breeding mosquitoes such as the dengue mosquito Aedes aegypti.

Most ovitraps collect eggs laid by mosquitoes visiting the trap and thus do not directly collect adult mosquitoes visiting the trap. Thus, the eggs have to be hatched and the larvae reared in order to establish the identity of mosquitoes that laid eggs in the trap. Clearly, this type of arrangement suffers from an unacceptable delay in determining the type of mosquito.

It is known to provide an ovitrap which traps the mosquitoes themselves. These ovitraps are known as “sticky ovitraps”. Basically, the sticky ovitrap contains a sticky adhesive to which the mosquito is stuck and which enables the mosquito to be identified.

These sticky ovitraps comprise a container having a volume typically between 500 ml-2000 ml. The container is partially filled with water. Sometimes, an attractant is added to the water. The inner and outer wall of the container should be dark and is typically either black or painted black otherwise the mosquitoes are reluctant to enter the container.

One known type of sticky ovitrap has the inner surface of the trap coated with a sticky glue down to the water level in the trap.

Another type of sticky ovitrap has a strip of thin black cardboard placed inside the trap and glue is smeared onto the cardboard strip.

In each instance, a mosquito entering into the trap can become stuck to the adhesive.

A disadvantage with the first type of known trap is that the glue is spread directly onto the black inside wall. This makes it very difficult to identify the mosquitoes both because the adhesive area cannot be removed from the trap and because it is difficult to quickly and accurately identify a mosquito body on a black background.

The second type of known trap makes an improvement by providing a removable cardboard strip. However, the cardboard strip must be painted or coloured black to encourage the mosquitoes to enter into the trap and this does not overcome the problem of accurately identifying the mosquito body on a black background. Moreover, the cardboard strip quickly degrades when wetted by water in the ovitrap, making it impractical for field application. Spacing the cardboard strip away from the water in the ovitrap may reduce the ability to trap adult mosquitoes.

A disadvantage with each above ovitrap is that to ensure that the mosquito is instantly held by the adhesive, the adhesive must be extremely aggressive. However, this extremely sticky property makes it very difficult to quickly and easily apply the adhesive either to the inside wall of the trap or to the cardboard strip. It is also difficult to ensure the application of a uniform layer. A uniform layer of adhesive is advantageous as it facilitates easy identification of the mosquito.

It will be clearly understood that, if a prior art publication is referred to herein, this reference does not constitute an admission that the publication forms part of the common general knowledge in the art in Australia or in any other country.

### OBJECT OF THE INVENTION

It is an object of the invention to provide a sticky ovitrap which may at least partially overcome the above-mentioned disadvantages or provide a useful or commercial choice.

In one form, the invention resides in an ovitrap, the ovitrap comprising a container, the inside wall of the container being a dark colour, and an at least partially clear strip member which contains an at least partially clear adhesive, the strip member being attachable to the inside of the container.

Suitably, the container is made of black plastic to provide the inside wall of the container with a dark colour.

When the strip member is attached to the inside black wall of the trap, the black colour will be visible through the clear strip and the clear adhesive which means that mosquitoes will not be deterred from entering the trap. However, when the strip is removed from the trap, it can be laid on a white background (or backlit) to make mosquito identification easier.

It is preferred that the strip member is made of plastic as, by having a plastic strip, the strip will not degrade in the container and can be stored for long periods of time for future use.

Moreover, by having a separate strip member, it may be easier to apply the adhesive to the strip member in a more uniform manner. For instance, a knife or blade can be used to smear on the adhesive in a substantially uniform manner.

Suitably, the strip member contains a pre-applied layer of adhesive, and the adhesive can then be applied in a very uniform manner. It is further preferred that some form of peel off layer is attached to the top of the adhesive. Thus, the peel off layer can be removed prior to inserting the strip member into the container.

The container may be made of any suitable material, however it is preferred that the container is made of black plastic. A suitable plastic will be polyethylene. The container may be made of other suitable material such as other types of plastics, plastic composites, metal, wood, coated or otherwise treated paper and cardboard, laminated materials and the like.

The container may be made of rigid or mainly rigid material such that the container is self-supporting or the container may be made of a flexible bag like material and may be provided with a framework to support the bag like material.

The container may be of any suitable shape and may be substantially cylindrical, rectangular, oval, may have other polygonal shapes, irregular shapes and the like. Suitably, the container will be substantially cylindrical.

The container can have a size and an internal volume which can depend on the number of mosquitoes to be trapped. A typical ovitrap will have an internal volume of between 500-2000 ml. This can however vary and no unnecessary limitation is meant thereby.

The container may be a “stand-alone” container or may be part of an array of containers or part of another item. The other item may comprise a support, a post, a cover, or any other type of item, it be appreciated that no unnecessary limitation is meant by the term container.

The container is preferably watertight to enable water to be kept in the container.

The container typically has an opening to allow the strip member to be placed into and removed from the container. Typically, the container has an open top which comprises the opening. However, the opening may comprise only part of the top of the container with the remainder of the container being closed. Alternatively, the opening may be provided on a side wall of the container. More than one opening may be provided if desired. The opening may be circular, oval, polygonal, strip like, irregular shapes and the like it being appreciated that no unnecessary limitation is to be placed on the type of opening.

If desired, some form of closure or partial closure may be provided on, adjacent, or around the opening. The closure may be desirable to prevent larger animals from falling into the container. Thus, in a simple form, the closure may comprise a mesh or screen extending over the opening. Alternatively, the closure may be substantially rigid and spaced somewhat above the opening to provide an entry slot between the closure and the opening. In a further alternative, the closure may comprise a separate structure which extends over the container. The separate structure may comprise a plurality of leg members and a cover member the cover member extending over the container to prevent rainfall and leaves from falling into the container or animals from making contact with the adhesive strip within the container. It is envisaged that the invention can extend to a two-part closure which contains the separate structure as well as a mesh. Again, no unnecessary limitation is to be placed on the existence of or the type of closure.

The clear strip member is suitably sufficiently clear to allow light to pass through the strip member. However, the strip member need not be entirely clear and may be somewhat opaque providing that some light can still pass through the strip member to provide a backlight to enable better identification of the mosquitoes stuck to the strip.

Various types of clear plastics can be used as the strip member, and it is considered that the person skilled in the art will be able to identify and provide a suitable clear plastic strip member.

The strip member should be sufficiently wide to enable mosquitoes to be trapped by the adhesive. It is therefore envisaged that the strip member will have a width of between 5-100 mm and typically between 10-50 mm. The size of the container may also determine the width of the strip member.

It is preferred that the strip member extends substantially about the inside wall of the container such that there are no appreciable gaps. This will facilitate catchment of mosquitoes. However, it is envisaged that a plurality of strip members may be provided which may be placed inside the container typically in a side-by-side relationship to form a substantially continuous strip. Although it is preferred that the strip member extends substantially about the inside wall of the container, it is envisaged that there may be circumstances where the strip member extends only partially about the wall of the container.

Suitably, the strip member is positioned in the container to extend just above the level of water in the container.

It is also envisaged that the entire inside wall of the container (typically from just above the waterline to the outlet) may be covered by the strip member.

The thickness of the strip member will typically be between about 1 mm-5 mm although this can vary to suit. It is preferred that the strip member is sufficiently flexible to enable it to be fitted inside the container but still sufficiently robust to be handled transported and stored.

It is also envisaged that the strip member can be pre formed to sit inside the container. Thus, the strip member may be manufactured in the form of a collar, insert, arcuate member and the like which can be placed in the container.

The adhesive which is applied to the strip member can vary but should be an adhesive which is aggressive enough to capture mosquitoes. Commercial adhesives are known that provide this function. The adhesive should be clear in the sense that when applied to the strip member, light can still pass through the strip member and the adhesive. Thus while it would be advantageous to provide an adhesive that is very clear, an adhesive that has better stick properties but which is slightly opaque may also be acceptable.

The thickness of adhesive applied to the strip member may depend on the type of adhesive used, the clearness of the adhesive etc. However, it is envisaged that the thickness will be <2 mm. However, no unnecessary limitation is meant thereby.

In a simple form, the adhesive may be smeared or coated onto the strip member prior to inserting the strip member into the container. However, it is preferred that the adhesive is pre-applied to the strip member and that some form of temporary protecting layer is present. The temporary protecting layer may be in the form of a peel off strip which can be peeled off to expose the adhesive prior to, or even after placing the strip member into the container.

The strip member can be provided as lengths which can be cut to a desired length and inserted into the container. Alternatively, the strip member can be provided as a roll of material. It is particularly preferred that the strip member comprises a roll of pre-coated adhesive having a protective peel off strip.

Therefore, another form of the invention comprises a strip member for an ovitrap, the strip member being substantially clear, one side of the strip member containing an adhesive which is also substantially clear, the adhesive being covered by a peel off protective layer.

The strip member can be supported in the container by any suitable means. In one form, the strip member may contains an adhesive on the other side of the strip member to allow the strip member to be temporarily attached to the inside wall of the container. Alternatively, tape, hooks, strings, clips, or any other type of fastening means may be provided to attach, suspend, or otherwise place the strip member in the container.

The container is at least partially filled with water. Typically, the container is approximately half filled with water. The water may contain an attractant to attract mosquitoes. The attractant may comprise an infusion of hay and water. The water may also contain a chemical to prevent mosquito breeding, a typical chemical being s-methoprene. It is also envisaged that the container may be filled with an aqueous gel, water crystals, or even water absorbing material to reduce water spillage, water evaporation, etc.

### BRIEF DESCRIPTION OF THE DRAWINGS

An embodiment of the invention will be described with reference to the following representations in which:

FIG. 1. Illustrates an ovitrap having three parts being a container, an adhesive strip and a cover mesh.

FIG. 2. Illustrates the adhesive strip being curved into a collar shape.

FIG. 3. Illustrates the adhesive strip attached to the inside wall of the black container, the container being partially filled with water.

FIG. 4. Illustrates the mesh attached over the top of the container.

FIG. 5. Illustrates mosquitoes (Culex quinquefasciatus, left, and Aedes aegypti right) trapped on the adhesive strip.

### BEST MODE

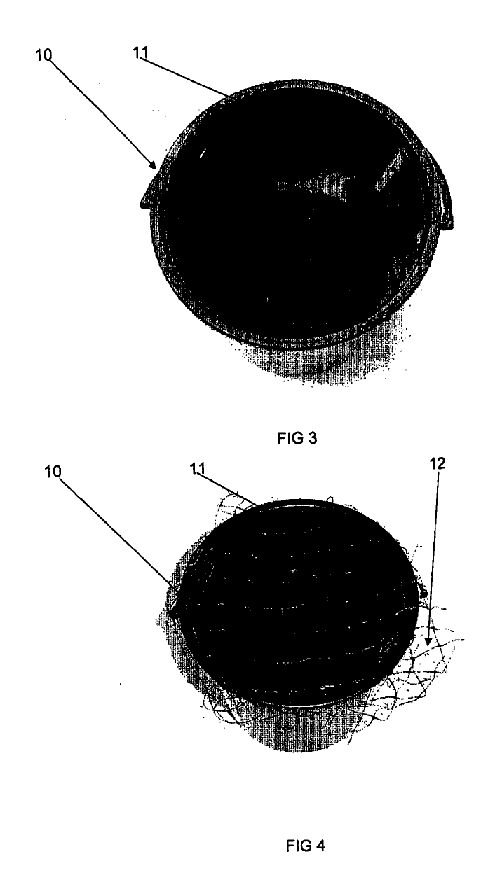

A 1.2-litre black plastic container 10 was used as the basic ovipositional container. Because the sides of the bucket were tapered, the adhesive strip 11 was cut from a sheet of overhead projector transparent plastic into an arc 5.5 cm×45 cm (top) and 36 cm (bottom) to fit snugly inside the top half of the bucket (see FIG. 3). A thin layer of polybutylene adhesive (Atlantic Paste and Glu Co., 170 53^{rd} St., Brooklyn, N.Y. 11232 USA) was applied to one side of the plastic strip using a paint scraper. Thorough coverage was achieved by folding the sticky sides of the plastic strip together and then gently moving the plastic to smear the glue evenly. The strip was unfolded and placed into the bucket sticky side out. The bucket was filled with 50% hay infusion until the water level reached the plastic strip, supplemented with 2 0.2-g pellets of lucerne (alfalfa) to enhance the infusion—see FIG. 3. A black plastic mesh 12 (1.7×1.7 cm holes) was secured over the bucket with an elastic band to prevent animals and people from contacting the glue.

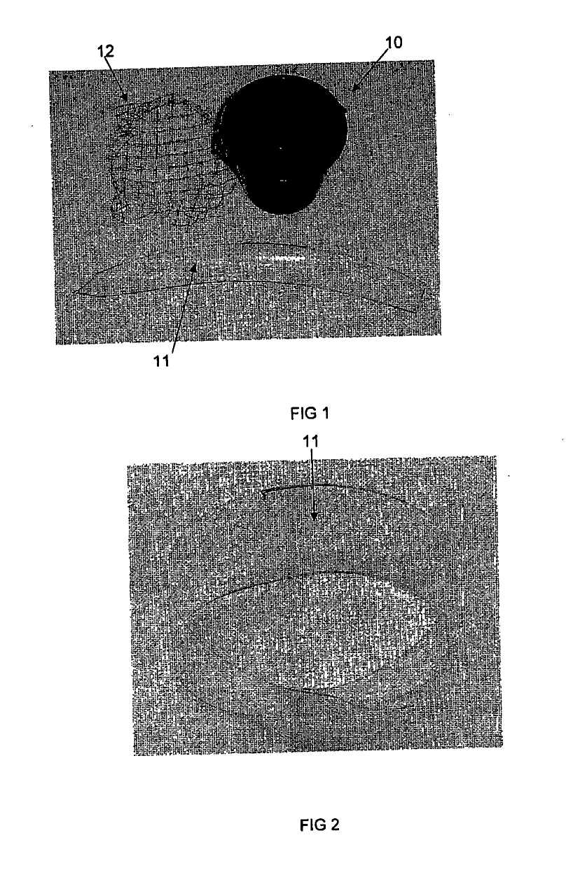

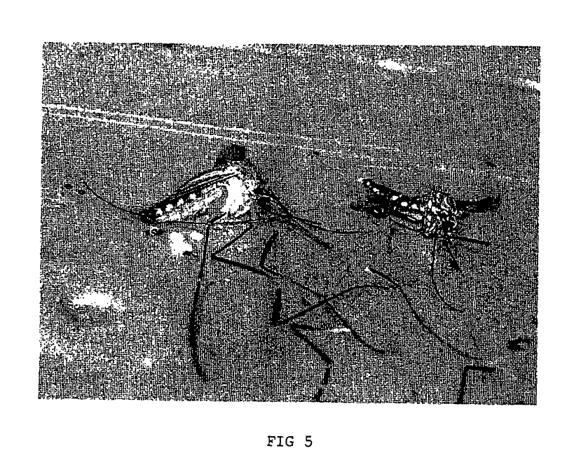

Particularly illustrated in FIG. 3 is that the clear plastic strip 11 when attached to the inside wall of the container, becomes a black colour which does not deter mosquitoes from entering into the container. However, when the strip 11 is removed from the container (see for instance FIG. 1), the strip is substantially clear and any mosquito attached to the strip can be very clearly seen. For instance, FIG. 5 illustrates mosquitoes trapped by the clear plastic strip.

In this particular embodiment, the strip 11 is supported inside container 10 by the strip of adhesive tape; however it should be appreciated that any other type of attachment means can also be used.

After a period of 1-7 days in the field, the ovitrap is returned to the lab. The adhesive strip is removed and placed sticky side up on a sheet of butchers paper. Mosquitoes are identified with the aid of a 10× handlens, although sections of the strip can be removed by cutting with a fine blade and placed under a microscope if necessary. The strip is generally discarded after use. Excess glue (on hands, scissors, etc.) can be removed using unscented baby oil then washing in soap and water.

Efficacy

The sticky ovitrap collected a wide variety of container-breeding mosquitoes, including the dengue vector, Aedes aegypti. Other important mosquitoes collected include Culex quinquefasciatus and Ochlerotatus notoscriptus, an important vector of Ross River virus and dog heartworm in Australia. The sticky ovitrap was as effective as the standard ovitrap in detecting Aedes aegypti, with 67.5% and 64% of traps positive for Ae. aegypti, respectively. However, because it collects adult mosquitoes, rather than detecting eggs that female mosquitoes have laid in a standard ovitrap, it is much more efficient as eggs do not have to be hatched and reared. This results in considerable savings in time and thus costs. Furthermore, actual direct counts of adult mosquitoes are obtained, an improvement over counts of eggs which can vary considerably. Finally, unlike conventional ovitraps, the adult mosquito is captured and thus killed, an important consideration when traps are used to monitor for exotic mosquito species at ports.

The sticky ovitrap also collects large numbers of flies, particularly house and blue/green bottle flies.

Applications

Routine monitoring of container-breeding mosquitoes by health workers. This includes container-breeding mosquitoes that carry dengue and other viruses such as Ross River virus and, potentially, West Nile virus.

Sticky ovitraps could be used in the surveillance for viruses carried by mosquitoes. Mosquitoes collected by the trap can be analysed for viruses such as dengue, Ross River and, potentially, West Nile.

Sticky ovitraps would be particularly useful for quarantine surveillance and the exclusion of exotic species from sea- and airports.

An array of sticky ovitraps could be used to control mosquitoes by removal trapping by health workers.

Sticky ovitraps could be used by homeowners to control mosquitoes, along with flies, in the home and yard.

Throughout the specification and the claims (if present), unless the context requires otherwise, the term “comprise”, or variations such as “comprises” or “comprising”, will be understood to apply the inclusion of the stated integer or group of integers but not the exclusion of any other integer or group of integers.

1. An ovitrap comprising a container, the inside of the container being a dark colour, and an at least partially clear strip member which contains an at least partially clear adhesive, the strip member being attachable to the inside of the container.

2. The ovitrap as claimed in claim 1, wherein the clear strip member is formed of plastic.

3. The ovitrap as claimed in claim 1, wherein the container is made of black plastic to provide the inside wall of the container with the dark colour.

4. The ovitrap as claimed in claim 1, wherein the strip member contains pre-coated adhesive and a peel off layer attached to the top of the adhesive.

5. The ovitrap as claimed in claim 1, wherein the container contains a chemical to prevent mosquitoes breeding.

6. The ovitrap as claimed in claim 1, wherein the container is bucket shaped.

7. The ovitrap as claimed in claim 1, wherein the internal volume of the container is between 500-2000 ml.

8. The ovitrap as claimed in claim 1, wherein the container has an open top.

9. The ovitrap as claimed in claim 8, containing a mesh extending over the open top to prevent larger animals passing into the container.

10. The ovitrap as claimed in claim 1, wherein the container is provided with a protective cover.

11. The ovitrap as claimed in claim 1, wherein the strip member has a width of between 10-100 mm.

12. The ovitrap as claimed in claim 1, wherein the strip member extends substantially about the inside wall of the container.

13. The ovitrap as claimed in claim 1, wherein the adhesive is a polybutylene adhesive.

14. The ovitrap as claimed in claim 1, wherein the adhesive is applied in a thickness of <2 mm to one side of the adhesive strip.

15. The ovitrap as claimed in claim 1, wherein the strip member is supported in the container to enable the strip member to the attached and removed from the container.

16. The ovitrap as claimed in claim 1, wherein the strip member comprises a plurality of smaller strip members.
